(19) United States
(12) Patent Application Publication
(10) Pub. No.: US 2008/0148520 A1
(43) Pub. Date: Jun. 26, 2008

(54) HINGE FOR LAPTOP COMPUTER

(76) Inventor: Jr-Jiun Chern, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/614,448

(22) Filed: Dec. 21, 2006

(51) Int. Cl. E05D 11/00

(52) U.S. Cl. 16/362

(57) ABSTRACT

A hinge is provided for a laptop computer. The hinge includes a first connector, a lining, a bush and a second connector. The first connector includes a root and a socket extended form the root. The lining is fit in the socket so that the lining cannot be rotated in the socket. The lining includes a positioning device disposed therein. The bush includes a positioning device engaged with the positioning device of the lining when the bush is inserted in the lining. Thus, the bush cannot be rotated in the lining. The second connector includes a shaft rotationally inserted in the bush and a plate extended from the shaft for connection to another portion of the laptop computer. Damping oil is provided between the bush and the shaft.

### BACKGROUND OF INVENTION

1. Field of the Invention

The present invention relates to a hinge and, more particularly, to a hinge for use in a laptop computer.

2. Related Prior Art

Taiwanese Patent Publication M296583 discloses a conventional hinge for a laptop computer. The hinge includes a base 10, two bushes 20, a shaft 30 and a seal 40. The base 10 defines a tunnel 11 throughout the length and three cutouts 13 at an end. Each of the bushes 20 is an arched elastic strip. The bushes 20 are disposed in the tunnel 11. The seal 40 defines an aperture 42 and includes three blocks 41 on the periphery. The seal 40 is disposed in the tunnel 11, with the blocks 41 fit in the cutouts 13. The shaft 30 is inserted in the aperture 42 of the seal 40, the bushes 20 and the tunnel 11 of the base 10. This conventional hinge is however expensive for at least two reasons. Firstly, the seal 40 adds the cost. Secondly, two bushes 20 must be used and directed in opposite directions to damp the rotation of the shaft 30 in opposite directions.

The present invention is therefore intended to obviate or at least alleviate the problems encountered in prior art.

### SUMMARY OF INVENTION

According to the present invention, a hinge is provided for a laptop computer. The hinge includes a first connector, a lining, a bush and a second connector. The first connector includes a root and a socket extended form the root. The lining is fit in the socket so that the lining cannot be rotated in the socket. The lining includes a positioning device disposed therein. The bush includes a positioning device engaged with the positioning device of the lining when the bush is inserted in the lining. Thus, the bush cannot be rotated in the lining. The second connector includes a shaft rotationally inserted in the bush and a plate extended from the shaft for connection to another portion of the laptop computer. Damping oil is provided between the bush and the shaft.

The primary advantage of the hinge according to the present invention is a low cost for using only one bush and omitting a seal.

Other advantages and features of the present invention will become apparent from the following description referring to the drawings.

### BRIEF DESCRIPTION OF DRAWINGS

The present invention will be described through detailed illustration of the preferred embodiment referring to the drawings.

FIG. 1 is a perspective view of a hinge according to the preferred embodiment of the present invention.

FIG. 2 is an exploded view of the hinge shown in FIG. 1.

FIG. 3 is a cross-sectional view of the hinge taken along a line 3-3 shown in FIG. 1.

FIG. 4 is a cross-sectional view of the hinge taken along a line 4-4 shown in FIG. 1.

FIG. 5 is a cross-sectional view of the hinge taken along a line 5-5 shown in FIG. 1.

FIG. 6 is a perspective view of the hinge shown in FIG. 1 in use.

FIG. 7 is a perspective view of an open laptop computer equipped with two hinges as shown in FIG. 1.

FIG. 8 is a perspective view of the laptop computer in a closed position other than the open position shown in FIG. 7.

### DETAILED DESCRIPTION OF PREFERRED EMBODIMENT

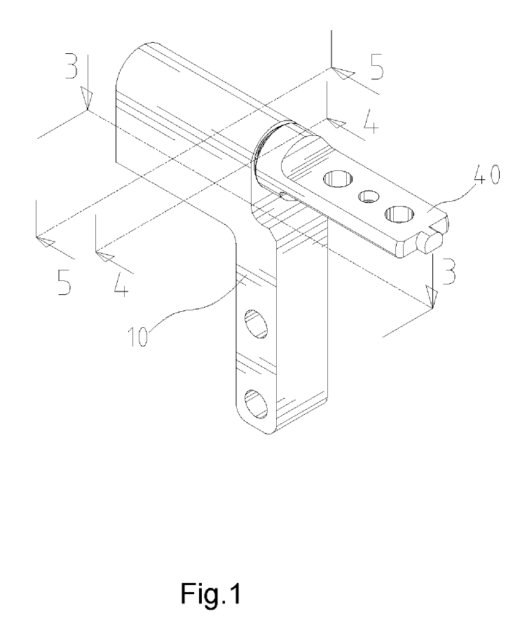

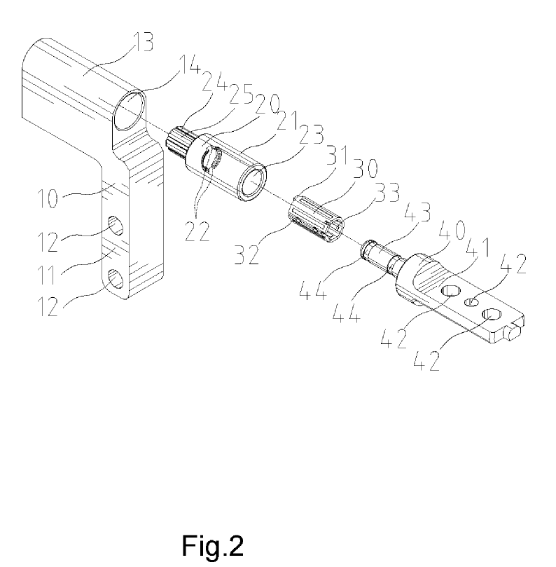

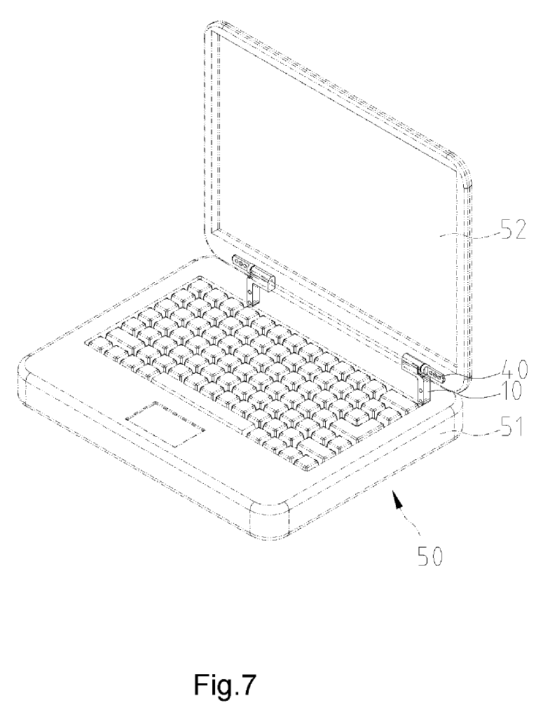

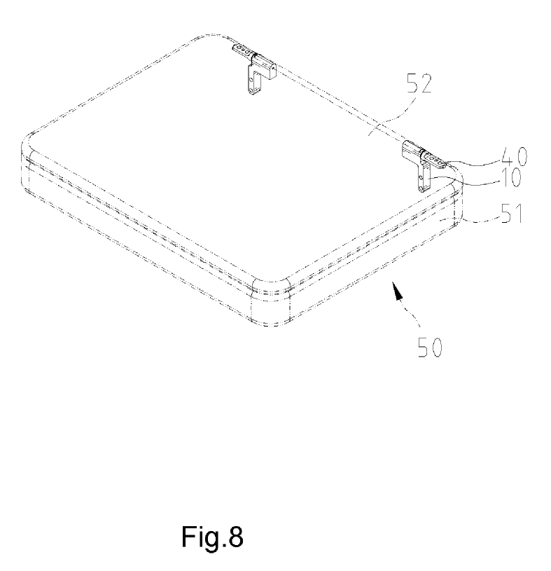

Referring to FIGS. 1 and 2, there is shown a hinge according to the preferred embodiment of the present invention. The hinge can be used in a laptop computer 50 including a host 51 and a liquid crystal display (“LCD”) 52 as shown in FIGS. 7 and 8. The hinge includes a first connector 10, a lining 20, a bush 30 and a second connector 40.

The first connector 10 includes a root 11 and a socket 13 transversely extended from the root 11. The root 11 defines two apertures 12 through which fasteners can be driven into the host 51 for connecting the root 11 to the host 51. The socket 13 defines a space 14 that includes a first portion and a second portion. The first portion of the space 14 is of a circular form when it is viewed in the axial direction. The second portion of the space 14 is of a non-circular form when it is viewed in a longitudinal direction. The second portion of the space 14 is smaller than the first portion of the space 14.

The lining 20 includes a tube 21 and an insert 24 axially extended from the tube 21. The tube 21 defines a space 23 and two recesses 22 in a closed end of the space 23. The recesses 22 are located opposite to each other. The insert 24 is of a non-circular form complementary to that of the second portion of the space 14. Preferably, grooves 25 are defined in the periphery of the insert 24. The insert 24 is split so that it is flexible.

The bush 30 includes a tubular configuration. A metal strip is rolled into the bush 30. A groove 32 is defined between two edges of the metal strip. That is, the groove 32 extends throughout a length of the bush 30. Thus, the bush 30 is flexible. The bush 30 is of a polygonal form when it is viewed in the axial direction. Ridges 33 are formed on the internal side of the bush 30 so that a valley is defined between any adjacent two of the ridges 33. The valleys are filled with damping oil. The bush 30 includes two tabs 31 extended from an end.

The second connector 40 includes a plate 41 and a shaft 43 axially extended from the plate 41. The plate 41 defines three apertures 42 through which fasteners can be driven into the LCD 52 for connecting the plate 41 to the LCD 52. The shaft 43 defines two annular grooves 44 for receiving the damping oil.

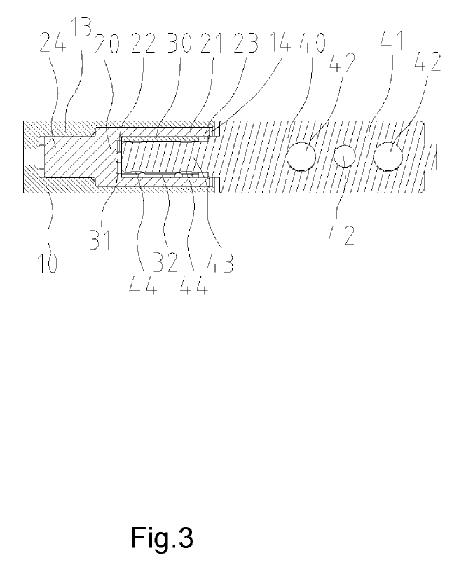

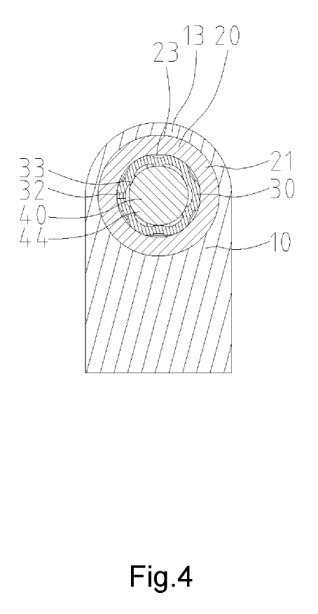

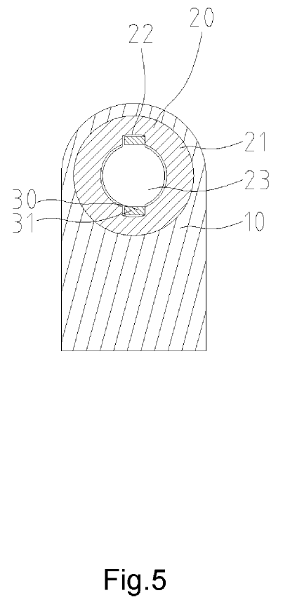

Referring to FIGS. 3 through 5, the insert 24 is inserted in the second portion of the space 14. Bring split, the insert 24 shrinks during the insertion. The insert 24 holds onto the wall of the second portion of the space 14 after the insertion. The tube 21 is inserted in the first portion of the space 14. Thus, the lining 20 is fit in the socket 13.

The bush 30 is inserted in the space 23, with the tabs 31 inserted in the recesses 22. Thus, the bush 30 is non-rotationally disposed in the lining 20. The split 32 allows the bush 30 to shrink during the insertion. The bush 30 holds onto the wall of the space 23 after the insertion.

The shaft 43 is inserted in the bush 30, with the periphery of the former contacting the internal side of the latter. The damping oil exists between the shaft 43 and the bush 30. Most of the damping oil exists in the valleys between the ridges 33 and the annular grooves 44.

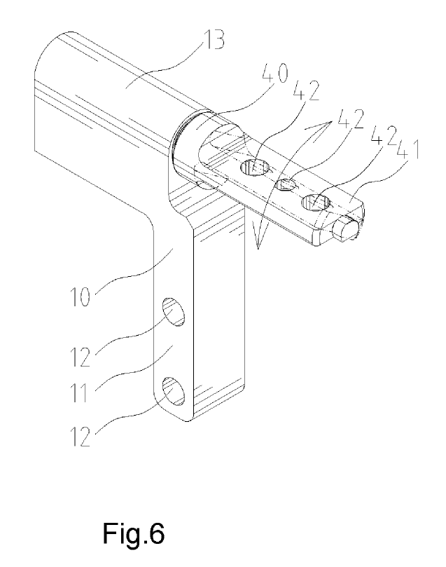

Referring to FIG. 6, the connectors 10 and 40 can be rotated relative to each other. The damping oil is provided between the bush 30 and shaft 43 to damp the rotation

Referring to FIGS. 7 and 8, the laptop computer 50 is equipped with two hinges as that is described in FIGS. 1 through 6.

Referring to FIG. 7, the LCD 52 is pivoted from the host 51. That is, the laptop computer 50 is open. The LCD 52 can be kept in any desired position pivoted from the host 51 due to the use of the hinge.

Referring to FIG. 8, the LCD 52 is pivoted to the host 51. That is, the laptop computer 50 is closed.

The hinge of the present invention exhibits at least three advantages. Firstly, no seal is needed. Secondly, because of the polygonal form, the bush 30 firmly holds the shaft 43, i.e., there is proper friction between the bush 30 and the shaft 43. Thirdly, the bush 30 is non-rotationally disposed in the lining 20 since the tabs 31 are inserted in the recesses 22.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A hinge comprising:
a first connector comprising a root for connection to a portion of a laptop computer and a socket extended form the root;
a lining non-rotationally disposed in the socket, the lining comprising a positioning device disposed therein;
a bush comprising a positioning device engaged with the positioning device of the lining when the bush is inserted in the lining so that the bush cannot be rotated in the lining;
a second connector comprising a shaft rotationally inserted in the bush and a plate extended from the shaft for connection to another portion of the laptop computer; and damping oil provided between the bush and the shaft.

2. The hinge according to claim 1 wherein the socket defines a space for receiving the lining.

3. The hinge according to claim 2 wherein the space comprises a first portion and a second portion, and the lining comprises a tube inserted in the first space of the socket and an insert inserted in the second space of the socket.

4. The hinge according to claim 3 wherein the insert is of a non-circular form when it is viewed in a longitudinal axial direction.

5. The hinge according to claim 3 wherein the tube defines a space and for receiving the bush.

6. The hinge according to claim 5 wherein the positioning device of the lining comprises at least one recess defined in a closed end of the space thereof, and the positioning device of the bush comprises at least one tab inserted in the recess.

7. The hinge according to claim 1 wherein the bush comprises a polygonal form when it is viewed in the axial direction.

8. The hinge according to claim 1 wherein the bush comprises ridges on the internal side, thus defining valleys between the ridges for receiving damping oil.

9. The hinge according to claim 1 wherein the shaft defines at least one annular groove for containing damping oil.
